(19) United States
(12) Patent Application Publication
(10) Pub. No.: US 2022/0186529 A1
(43) Pub. Date: Jun. 16, 2022

(54) DOOR SYSTEM FOR MOTOR VEHICLES PROVIDING POWER PRESENT AND HOLD FUNCTIONS AND EQUIPPED WITH A CLOSURE LATCH ASSEMBLY HAVING A POWER RELEASE AND SAFETY CATCH ARRANGEMENT

(71) Applicant: MAGNA CLOSURES INC., Newmarket (CA)

(72) Inventor: Francesco Cumbo, Pisa (IT)

(21) Appl. No.: 17/549,334

(22) Filed: Dec. 13, 2021

Related U.S. Application Data
(60) Provisional application No. 63/126,171, filed on Dec. 16, 2020.

(51) Int. Cl. E05B 77/00; B60J 5/04; E05B 81/06; E05B 81/20; E05B 83/38; E05F 15/622

(52) U.S. Cl. CPC E05B 77/00; B60J 5/0479; E05B 81/06; E05B 81/20; E05B 83/38; E05Y 2900/531; E05Y 2201/434; E05Y 2201/70; E05Y 2201/702; E05Y 2400/52; E05F 15/622

(57) ABSTRACT

A door system and related method for a passenger door for a motor vehicle is provided for preventing inadvertent movement of the passenger door from a presented position toward an open position and a closed position until desired. The system includes latch with a safety catch and a door presenter. The latch and door presenter are configured for coordinated movement to allow the door to move from the closed position to the presented position and to be maintained in the presented position. The safety catch blocks the door from moving to the open position, and the door presenter blocks the door from moving to the closed position. Subsequent actuation releases the safety catch or retracts the door presenter to allow the door to open or close from the presented position.

### CROSS-REFERENCE TO RELATED APPLICATIONS

The present application claims the benefit of previously filed U.S. Provisional Patent Application No. 63/126,171, filed Dec. 16, 2020, the entire content of which is hereby incorporated by reference in its entirety.

### FIELD

The present disclosure relates to power door systems for motor vehicles, and more particularly, to power door systems including a power door presenter operable for moving a vehicle door relative to a vehicle body between a closed position and a presented position and including a power latch assembly for releasably holding the vehicle door in the closed position and the presented position.

### BACKGROUND

Passenger doors on motor vehicles are typically mounted by upper and lower door hinges to the vehicle body for swinging movement about a generally vertical pivot axis. Such swinging passenger doors (“swing doors”) have recognized issues such as, for example, when the vehicle is situated on an inclined surface and a closure latch assembly is released, the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding (i.e checking) the door in one or more mid-travel positions in addition to a fully-open position.

In view of increased consumer demand for motor vehicles equipped with advanced comfort and convenience features, many current vehicles are now provided with passive keyless entry systems to permit locking and release of the passenger doors without the use of traditional key-type manual entry systems. In this regard, some of the more popular features now provided with vehicle closure systems include power locking/unlocking and power release. These “powered” features are typically integrated into a primary latch assembly mounted to the passenger door and which is configured to include a latch mechanism, a latch release mechanism and at least one electric actuator. As is known, movement of the passenger door to its closed position causes the latch mechanism to engage a striker (mounted to the vehicle body) and shift the primary latch assembly into a latched mode to releasably hold the passenger door in its closed position. To subsequently release the passenger door for movement from its closed position toward an open position, an electric “power release” actuator can actuate the latch release mechanism to mechanically release the striker from the latch mechanism and shift the primary latch assembly into an unlatched mode.

As a further advancement, power door actuation systems have been developed which function to automatically swing the passenger door about its pivot axis between its open and closed positions. Typically, power door actuation systems include a power-operated device such as, for example, a power swing door actuator having an electric motor and a rotary-to-linear conversion device that are operable for converting the rotary output of the electric motor into translational movement of an extensible member. In many power door actuator arrangements, the power swing door actuator is mounted to the passenger door and the distal end of the extensible member is fixedly secured to the vehicle body. One example of a door-mounted power door actuation system is shown in commonly-owned U.S. Pat. No. 9,174,517 with a power swing door actuator having a rotary-to-linear conversion device configured to include an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions. Operation of the power swing door actuator is controlled in coordination with the power release operation of the primary latch assembly via the passive keyless entry system.

Some other door actuation systems, known as door presenter systems, are configured to include a power-operated door presenter assembly operable to “present” the door upon the closure latch assembly being released by opening it only a predetermined amount to a partially-open position so as to allow subsequent manual movement of the door to its fully-open position.

Because the door presenter assembly is typically activated by the passive keyless entry system in conjunction with power release of the primary closure latch assembly, upon the passenger door being presented to its partially-open position, the passenger door is able to be freely moved to its fully-open position. As such, the passenger door, upon being presented, is able to move unintentionally toward its fully-open position under gravity and wind forces.

In view of the above, there remains a need to develop alternative passenger door systems including a power door presenter and closure latch assembly which address and overcome limitations associated with known power door actuation systems as well as to provide increased applicability while reducing cost and complexity.

### SUMMARY

This section provides a general summary of the present disclosure and is not a comprehensive disclosure of its full scope or all of its features, aspects and objectives.

In accordance with an aspect of the disclosure, a door system for a passenger door of a motor vehicle is provided, wherein the door system addresses the issues discussed above with known door systems.

In accordance with an aspect of the disclosure, a latch assembly for a door system is provided, wherein the latch assembly addresses the issues discussed above with known latch assemblies.

In accordance with an aspect of the disclosure, a latch assembly and a presenter of a door system is provided, wherein the latch assembly and presenter address the issues discussed above with known door systems.

In accordance with an aspect of the disclosure, the door system can be provided such that the latch assembly is configured for a first actuation to release the passenger door from its closed position, whereupon the presenter is configured to move the passenger door from its closed position to its partially-open position, whereat the latch assembly is configured to releasably maintain the passenger door in its partially-open position, and wherein the latch assembly is further configured for a second actuation to release the latch assembly from holding the passenger door in its partially-open position for desired movement to its fully-open position.

In accordance with an aspect of the disclosure, the latch assembly and presenter of the door system can be configured to be actuated remotely from the motor vehicle.

In accordance with an aspect of the disclosure, the passenger door can be handle-less.

In accordance with an aspect of the disclosure, passenger door can be devoid of a B-pillar.an

In accordance with another aspect of the disclosure, a door system for a passenger door of a motor vehicle is configured for pivotal movement between a closed position, a presented position and an open position, and includes a latch assembly having a housing; a ratchet mounted to the housing for pivoting movement between a primary striker capture position whereat the ratchet retains a striker mounted to the motor vehicle in a locked position to releasably maintain the passenger door in the closed position, a secondary striker capture position whereat the ratchet retains the striker against full release from the ratchet to releasably prevent movement of the passenger door from the presented position toward the open position, and a striker release position whereat the ratchet releases the striker to allow the passenger door to be moved to the open position, wherein the ratchet is biased toward the striker release position; at least one pawl configured for operable communication with a release member and being mounted to the housing for pivoting movement between a primary locking position whereat the pawl is positioned to retain the ratchet in the primary striker capture position, a secondary locking position whereat the pawl is positioned to retain the ratchet in the secondary striker capture position, and an unlocking position whereat the pawl is positioned to allow the ratchet to move to the striker release position, the pawl being biased toward the primary locking position; and a presenter mechanism for moving the door from a closed position to a presented position. The presenter mechanism may have for example an extensible member moveable between a retracted position whereat the passenger door is able to be moved to the closed position and an extended position whereat the passenger door is moved to the presented position, wherein movement of presenter mechanism, such as for example movement of the extensible member from the retracted position to the extended position, is coordinated with movement of the ratchet from the primary striker capture position to the secondary striker capture position.

In accordance with another aspect of the disclosure, the latch assembly includes a latch actuator operable to move the pawl from the primary locking position to the secondary locking position and from the secondary locking position to the unlocking position, and wherein the presenter includes a presenter actuator operable to move the extensible member from the retracted position to the extended position, and further including a controller operable to coordinate actuation of the latch actuator and the presenter actuator relative to one another.

In accordance with another aspect of the disclosure, the controller is configured to signal actuation of the latch actuator concurrently with actuation of the presenter actuator to cause the pawl to move from the primary locking position to the secondary locking position at substantially the same time as the extensible member moves from the retracted position to the extended position.

In accordance with another aspect of the disclosure, the latch actuator is configured to maintain the pawl in the secondary locking position, with the ratchet in the secondary striker capture position, while the extensible member is in the extended position, thereby releasably maintaining the passenger door in the presented position absent the controller signaling the latch actuator to move the pawl to the unlocking position.

In accordance with another aspect of the disclosure, the presenter actuator is configured to maintain the extensible member in the extended position to prevent inadvertent movement of the passenger door from the presented position to the closed position while the pawl is in the secondary locking position.

In accordance with another aspect of the disclosure, the door system can include a switch configured for manual actuation to signal the latch actuator to move the pawl from the secondary locking position to the unlocking position to allow the ratchet to move from the secondary striker capture position to the striker release position when desired to move the passenger door from the presented position to the open position.

In accordance with another aspect of the disclosure, the switch is further configured to signal the presenter actuator to move the extensible member from the extended position to the retracted position

In accordance with another aspect of the disclosure, the switch can be located on an inner side of an edge of the passenger door such that the switch becomes accessible for manual actuation when the passenger door is moved from the closed position to the presented position.

In accordance with another aspect, the disclosure is directed to a method of constructing a passenger door of a motor vehicle for release from a closed position to a presented position and for maintaining the passenger door in the presented position until desired to move the passenger door to an open position or back to the closed position.

In accordance with another aspect, the disclosure is directed to a method for preventing inadvertent pivotal movement of a passenger door of a motor vehicle from a presented position toward an open position and a closed position.

In accordance with another aspect, the disclosure is directed to a method for regulating pivotal movement of a passenger door of a motor vehicle between a closed position, a presented position and an open position.

In accordance with another aspect of the disclosure, a method of constructing a passenger door of a motor vehicle for release from a closed position to a presented position and for maintaining the passenger door in the presented position until desired to move the passenger door to an open position or back to the closed position, includes: providing the passenger door with a latch assembly having a ratchet mounted for pivoting movement between a primary striker capture position whereat the ratchet retains a striker mounted to the motor vehicle in a locked position to releasably maintain the passenger door in the closed position, a secondary striker capture position whereat the ratchet retains the striker against full release from the ratchet to hold the passenger door in the presented position, and a striker release position whereat the ratchet releases the striker to allow the passenger door to be moved to the open position; further, providing the latch assembly having at least one pawl for operable communication with a release member for pivoting movement between a primary locking position whereat the at least one pawl is positioned to retain the ratchet in the primary striker capture position, a secondary locking position whereat the at least one pawl is positioned to retain the ratchet in the secondary striker capture position, and an unlocking position whereat the at least one pawl is positioned to allow the ratchet to move to the striker release position; further, coupling a fixed support of the motor vehicle to the passenger door with a presenter having an extensible member moveable between a retracted position whereat the passenger door is in the closed position and an extended position whereat the passenger door is moved to the presented position; and, coupling the presenter and the latch assembly in operable communication with one another for movement of the extensible member from the retracted position to the extended position in response to movement of the ratchet from the primary striker capture position to the secondary striker capture position.

In accordance with another aspect of the disclosure, the method can further include providing the latch assembly with a latch actuator operable to move the pawl from the primary locking position to the secondary locking position and from the secondary locking position to the unlocking position and providing the presenter with a presenter actuator operable to move the extensible member from the retracted position to the extended position, and coordinating actuation of the latch actuator and the presenter actuator relative to one another with a controller.

In accordance with another aspect of the disclosure, the method can further include configuring the controller to signal actuation of the latch actuator in timed relation with actuation of the presenter actuator.

In accordance with another aspect of the disclosure, the method can further include configuring the controller to signal actuation of the latch actuator concurrently with actuation of the presenter actuator.

In accordance with another aspect of the disclosure, the method can further include configuring the latch actuator to maintain the pawl in the secondary locking position and the ratchet in the secondary striker capture position while the extensible member is in the extended position to releasably maintain the passenger door in the presented position, thereby preventing inadvertent movement of the passenger door from the presented position.

In accordance with another aspect of the disclosure, the method can further include configuring the presenter actuator to maintain the extensible member in the extended position to prevent inadvertent movement of the passenger door from the presented position to the closed position while the pawl is in the secondary locking position.

In accordance with another aspect of the disclosure, the method can further include configuring a switch for manual actuation to signal the latch actuator to move the pawl from the secondary locking position to the unlocking position to allow the ratchet to move from the secondary striker capture position to the striker release position when desired to move the passenger door from the presented position to the open position.

In accordance with another aspect of the disclosure, the method can further include locating the switch on an inner side of an edge of the passenger door such that the switch becomes accessible for manual actuation while the passenger door is in the presented position.

In accordance with another aspect, a door system for a passenger door of a motor vehicle configured for movement between a closed position, a presented position, and an open position, includes: a presenter having an extensible member moveable from a retracted position whereat the passenger door is able to be moved to the closed position to an extended position whereat the passenger door is moved by the extensible member to the presented position; and a latch assembly having a safety catch configured for movement between a striker safety capture position whereat the safety catch retains a striker in a blocked position when the door is in the presented position to prevent the passenger door from moving to the open position from the presented position, and a striker safety release position whereat the safety catch releases the striker from the blocked position to allow the passenger door to be moved from the presented position to the open position.

In one aspect, when the passenger door is in the presented position, the extensible member is in the extended position, and the safety catch is in the striker safety capture position, the passenger door is prevented from moving away from the presented position.

In one aspect, the latch assembly comprises a ratchet and pawl assembly configured to maintain the striker in a striker safety capture position to prevent the door from moving from the closed position to the presented position, wherein a first actuation of the latch assembly causes the ratchet and pawl assembly to release the striker to allow the door to move from the closed position to the presented position, and a second actuation of the latch assembly causes the safety latch to move from the striker safety capture position to the striker safety release position to release the striker to allow the door to move from the presented position to the open position.

In one aspect, movement of the safety catch to the striker safety capture position is coordinated with movement of the extensible member to the extended position.

In one aspect, the system includes a controller operable to coordinate the movement of the safety catch with the movement of the extensible member .

In one aspect, the system includes a switch configured to signal movement of the safety catch from the striker safety catch position to the striker safety release position.

In one aspect, the switch is further configured to signal movement of the extensible member from the extended position to the retracted position.

In one aspect, a method of controlling movement of a passenger door of a motor vehicle from a closed position to a presented position is provided, including the steps of: controlling a presenter having an extensible member moveable between a retracted position and an extended position to correspondingly move the door from the closed position to the presented position when the extensible member moves from the retracted position to the extended position; and controlling a latch assembly having a safety catch moveable between a striker safety capture position, whereat the safety catch blocks a striker provided on one of the passenger door and a body of the motor vehicle to prevent the passenger door from moving to the open position from the presented position, and a striker safety release position, whereat the safety catch unblocks the striker to allow the passenger door to be moved from the presented position to the open position.

In one aspect, the method includes the step of controlling the presenter to maintain the extensible member in the extended position prior to controlling the latch assembly to move the safety catch from the striker safety capture position to the striker release position to allow the door to move from the presented position to the open position but not move from the presented position to the closed position.

In one aspect, the method includes the step of controlling the presenter to move the extensible member from the extended position to the retracted position prior to controlling the latch assembly to move the safety catch from the striker capture position to the striker release position to allow the door to move from the presented position to the closed position but not move from the presented position to the open position.

In one aspect, the method includes coordinating movement of the safety catch to the striker safety capture position from a striker capture position with movement of the extensible member to the extended position from the retracted position.

In one aspect, the method includes maintaining the door in the presented position and blocking movement toward the closed position by the extensible member and blocking movement toward the open position by the safety catch.

In one aspect, the method includes the step of providing a ratchet and pawl assembly provided as part of a latch assembly configured to maintain the striker in a striker capture position to prevent the door from moving from the closed position to the presented position and configured to release the striker to allow the door to move from the closed position towards the one of the open position and the presented position; controlling a first actuation of the latch assembly to cause the ratchet and pawl assembly to release the striker to allow the door to move from the closed position to the presented position, and controlling a second actuation of the latch assembly to cause the safety catch to move from the striker safety capture position to the striker safety release position to allow the door to move from the presented position to the open position.

### BRIEF DESCRIPTION OF THE DRAWINGS

These and other objects, features and advantages of the present disclosure will be readily appreciated, as the same becomes better understood by reference to the following detailed description when considered in connection with the accompanying drawings, wherein:

FIG. 1 is a perspective view of a motor vehicle equipped with a pillar-less dual-door closure system;

FIG. 2 is a side elevational view of the motor vehicle shown in FIG. 1 with the doors of the dual-door closure system located in a closed position;

FIG. 3 is a side isometric view of the motor vehicle shown in FIG. 1 with the doors of the dual-door closure system located in a partially open position;

FIG. 4 illustrates an interior view of a door of the motor vehicle with an interior panel removed for clarity of viewing a door system including at least one latch assembly and a presenter;

FIGS. 5A-5C illustrate a latch assembly of the door system shown in fully latched (door closed), partially released (door presented), and fully released (door fully open) states;

FIG. 6 is a perspective view of a presenter assembly in accordance with an illustrative embodiment;

FIG. 7 illustrates the power door actuation system having a presenter assembly mounted to the vehicle body, in accordance with an illustrative embodiment;

FIGS. 8A and 8B are cross-sectional views of the presenter assembly of the power door actuation system shown in FIG. 5 taken along the line 8-8 of FIG. 5, illustrating the door presenter assembly in a deployed or extended state, and a retracted state, respectively;

FIGS. 9 and 10 are perspective views of the presenter assembly of FIG. 6, having a housing cover removed to illustrate the various internal components;

FIG. 11 is a view similar to FIG. 8A with the extensible member thereof shown in an extended state, illustrating the application of a force to return the extensible member to a retracted position;

FIGS. 12A and 12B are opposite side views of a double pull latch assembly associated with the vehicle shown in FIG. 1 shown in a fully latched position and constructed according to another aspect of the present disclosure;

FIGS. 13A and 13B are views similar to FIGS. 12A and 12B with the double pull latch assembly shown during a first actuation of a primary pawl;

FIGS. 14A and 14B are views similar to FIGS. 13A and 13B with the double pull latch assembly shown after completion of the first actuation;

FIGS. 15A and 15B are views similar to FIGS. 13A and 13B with the double pull latch assembly shown after a second actuation of a primary pawl with the double pull latch assembly shown in a fully open position;

FIGS. 16A and 16B are views similar to FIGS. 12A and 12B with the double pull latch assembly shown while the vehicle is in a predetermined condition causing an actuator to move a coupling lever to a disengaged position;

FIGS. 17A and 17B are views similar to FIGS. 16A and 16B with the double pull latch assembly shown during a first actuation of primary pawl with the coupling lever moved to the disengaged position;

FIGS. 18A and 18B are views similar to FIGS. 17A and 17B with the double pull latch assembly shown after completion of the first actuation of the primary pawl and with a ratchet in the second closed position;

FIGS. 19A and 19B are views similar to FIGS. 18A and 18B illustrating how a second actuation of the primary pawl does not cause the release of a secondary pawl due to the coupling lever being moved to the disengaged position;

FIG. 20 is a side view of a double pull latch assembly associated with the vehicle shown in FIG. 1 shown in a fully latched position and constructed according to another aspect of the present disclosure;

FIG. 21 is a view similar to FIG. 20 with the double pull latch assembly shown during a first actuation of a pawl to a secondary locking position;

FIG. 22 is a view similar to FIG. 21 with the double pull latch assembly shown during a second actuation of a pawl to an unlocking position;

FIG. 23 is a method of operating a power release double pull latch, in accordance with an illustrative embodiment;

FIG. 24 is a method of operating a safety catch and door presenter, accordance with an illustrative embodiment; and

FIG. 25 is a method of controlling a present and hold door system, in accordance with an illustrative embodiment.

### DETAILED DESCRIPTION OF EXAMPLE EMBODIMENTS

In general, example embodiments including a door system for motor vehicles providing power present and hold functions and equipped with closure latch assembly having power release and safety catch arrangement constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

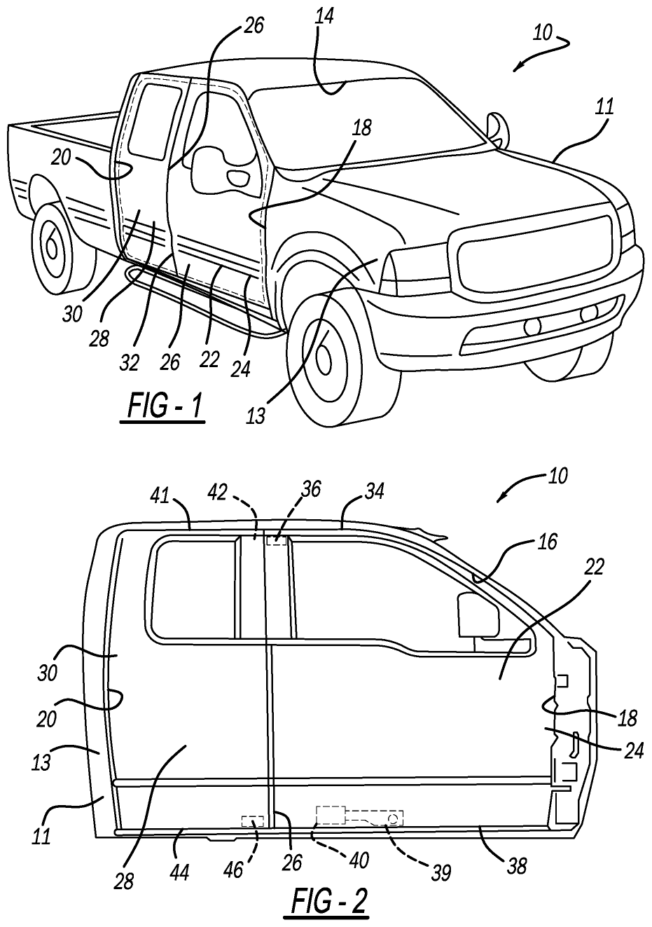

Referring initially to FIGS. 1-3, a motor vehicle 10 is shown configured as a pickup truck, by way of example and without limitation, including a vehicle body 11 (forming a fixed support) having an exterior 13 and an interior 14 defining a passenger compartment. Connecting exterior 13 and interior 14 of vehicle body 11 is a continuous or “pillar-less” (no B-pillar) side opening 16 defining a first or front terminal end 18 of side opening 16 and a second or rear terminal end 20 of side opening 16. Providing a first moveable closure member for a front portion of opening 16 is a first or front door 22 having a forward portion 24 pivotably connected via front hinges (not shown) to vehicle body 11 adjacent to front terminal end 18 of opening 16. Front door 22 has a rearward portion 26 generally opposite its pivotal connection to vehicle body 11. Providing a second moveable closure member for a rear portion of opening 16 is a second or rear door 28. Rear door 28 has a rearward portion 30 which is pivotably connected via rear hinges (not shown) to vehicle body 11 adjacent to rear terminal end 20 of opening 16 and has a forward portion 32 generally opposite to its pivotal connection. When front door 22 and rear door 28 are closed together, the extreme end of rearward portion 26 of front door 22 overlaps and is latched to the extreme end of forward portion 32 of rear door 28. Accordingly, front door 22 and rear door 28 together define a pillar-less dual-door closure arrangement.

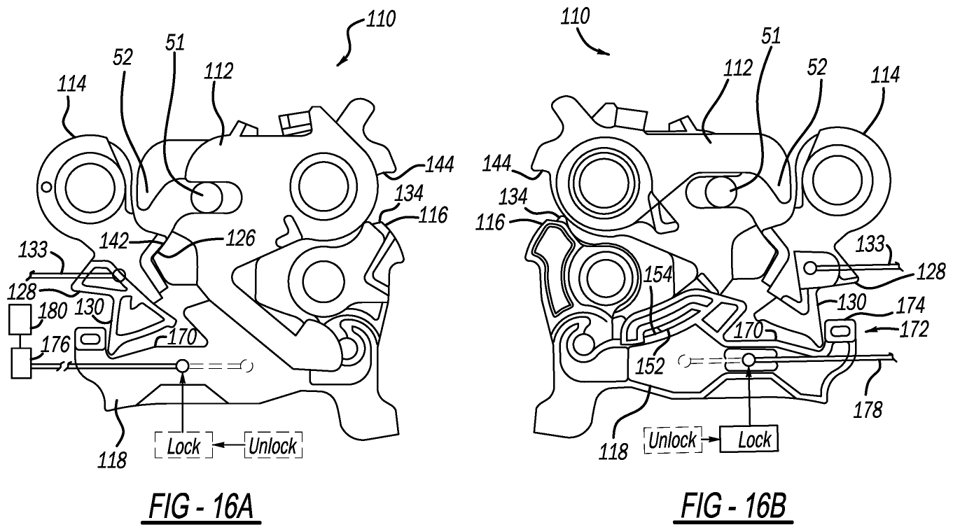

Front door 22 has a door system 33 and is schematically shown along its upper edge 34 to have a releasable latched connection via a first front closure latch assembly 36 of door system 33 with vehicle body 11 at a location between front and rear terminal ends 18 and 20 of opening 16. Front door 28 is also schematically shown along a bottom edge 38 to have a releasable latched connection via a second front closure latch assembly 40 of door system 33 with vehicle body 11 at a location between front and rear terminal ends 18 and 20 of opening 16. Door system 33 further includes a presenter 39 configured in operable communication with at least one or both of the first and second front closure latch assemblies 36, 40, wherein presenter 39 couples a fixed support (vehicle body 11) of the motor vehicle 10 to the passenger door 22 such that presenter 39 is operable to move front door 22 under power of a presenter actuator 55 from a closed position to a presented position in response to actuation of one or both of the first and second front closure latch assemblies 36, 40 via latch actuator 176 (FIG. 16A). Rear door 28 is also schematically shown along its upper edge 41 to have a releasable latched connection via a first rear closure latch assembly 42 with vehicle body 11 at a location between front and rear terminal ends 18 and 20 of opening 16. Rear door 28 is also schematically shown along a bottom edge 44 to have a releasable latched connection via a second rear closure latch assembly 46 with vehicle body 11 at a location between front and rear terminal ends 18 and 20 of opening 16.

Those skilled in the art will recognize that the particular location of first and second front closure latch assemblies 36, 40 and first and second rear closure latch assemblies 42, 46 shown in FIGS. 1-3 is merely intended to illustrate one exemplary dual-door latching arrangement and is not intended to limit the present disclosure. The door system 33 described herein may also be employed in single door latching arrangements, where a closure latch assembly is arranged on a vehicle door and operable to releaseably latch a striker fixed to the rearward sill of the vehicle body 11 or a pillar (e.g. B-pillar) adjacent to the door.

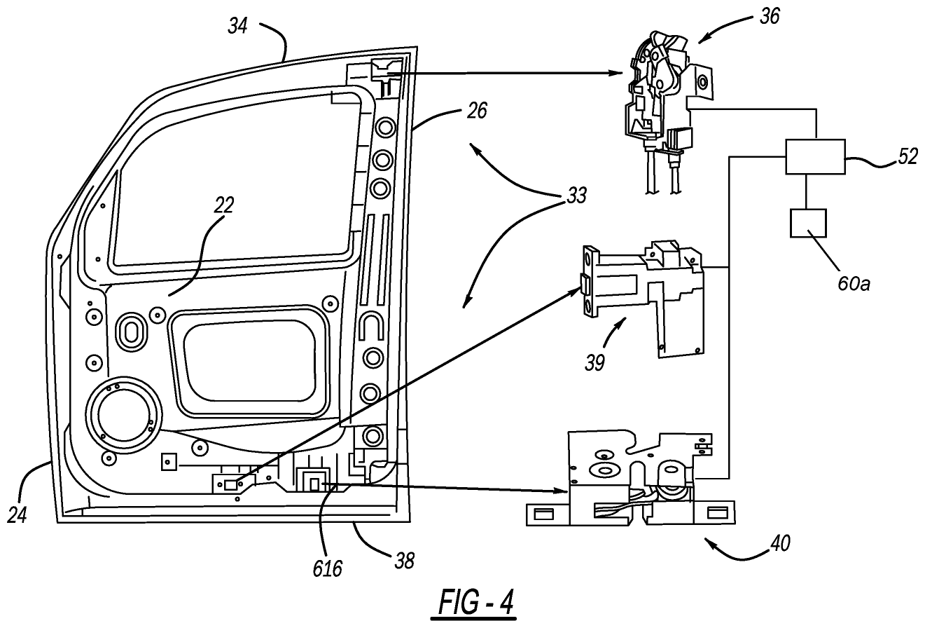

FIG. 4 illustrates an interior view of front door with an inner panel removed for clarity of door system 33. Door system 33 is shown as a unitary module, including first front closure latch assembly 36, second front closure latch assembly 40 and presenter 39, though it is contemplated herein that one or more of the components could be separately detached from the others, though maintained in operable communication therewith.

FIG. 4 illustrates, in one aspect, a handle-less and B-pillar-less present and hold system. The first closure latch assembly 36 may also be referred to as an upper latch 36. The upper latch 36 includes cinch capability. The remote door presenter 39 is shown forward relative to the second front closure latch assembly 40, which may also be referred to as lower latch 40, although the presenter 39 could be disposed elsewhere in another aspect. The latch 40 includes an integrated safety catch, which will be further described below. After a first power release operation, the upper latch 36 and lower latch 40 will be released and the door presenter 36 may push the door open. After the first door opening operation, the striker is captured by the safety catch. Thus, the door is presented by not fully released, and held in position by the safety catch. Upon a second power release operation, which may be provided by the user, the safety catch releases and the door may be fully opened.

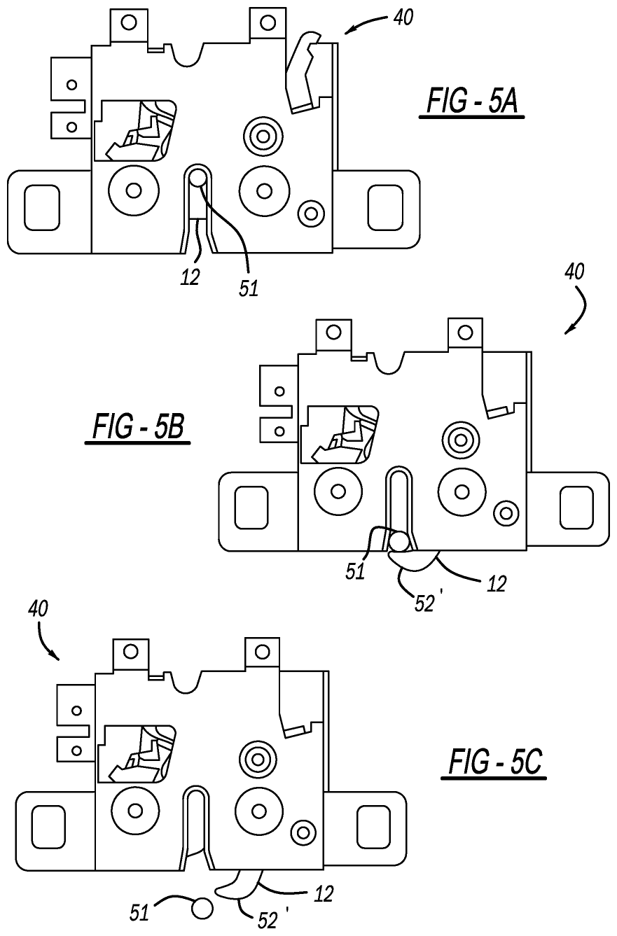

FIGS. 5A to 5C illustrate one of first and second front closure latch assemblies 36, 40 in different states of deployment, and referred to hereafter as second front latch assembly 40 for convenience. In FIG. 5A, second front latch assembly 40 is shown in a closed, also referred to as locked or latched state, wherein a ratchet 12 of second front latch assembly 40 is in a primary striker capture position to releasably hold and maintain a striker 51 in a fully locked position. In FIG. 5B, second front latch assembly 40 is shown in a partially released state, wherein the ratchet 12 is moved from the primary striker capture position to a secondary striker capture position, whereat the striker 51 is prevented from being released from second front closure latch assembly 40 by a hook-shaped safety catch portion 52 of ratchet 12. In FIG. 5C, second front latch assembly 40 is shown in a fully released state, wherein the ratchet 12 is moved from the secondary striker capture position to a striker release position, whereat the striker 51 is able to be freely moved and release from second front latch assembly 40 to allow front door 22 to be moved from the presented position to an open position.

With reference again to FIG. 4, the latch 40 may be arranged on the door structure and oriented such that the slot that receives and releases the striker extends in a lateral direction relative to the vehicle, thereby allowing the door to pivot outward. It will be appreciated that other arrangements and orientations of the latch 40 may be used depending on the desired direction of the door opening and being presented. Similarly, the latch 36 and door presented may be arranged to permit outward movement of the door and cause outward movement of the door, respectively.

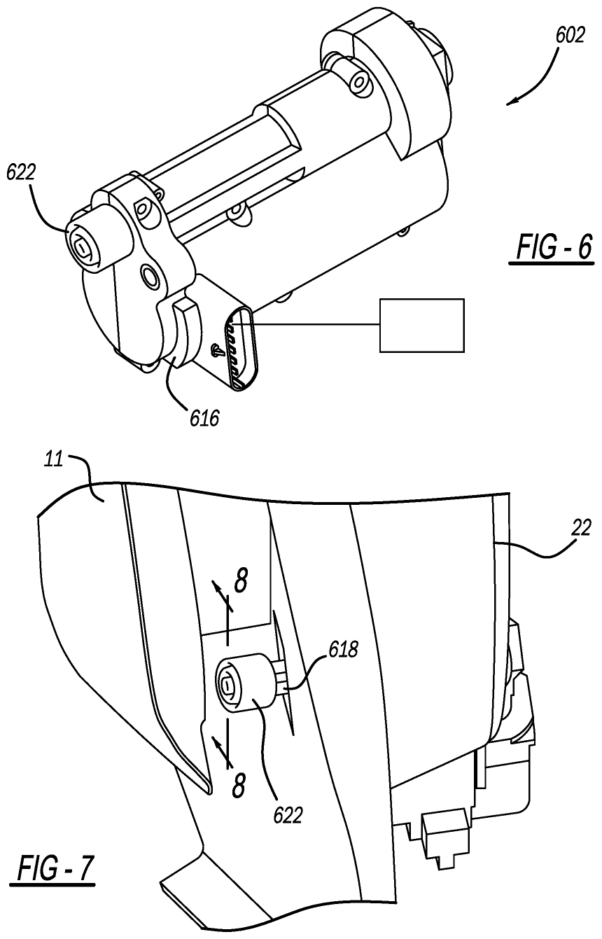

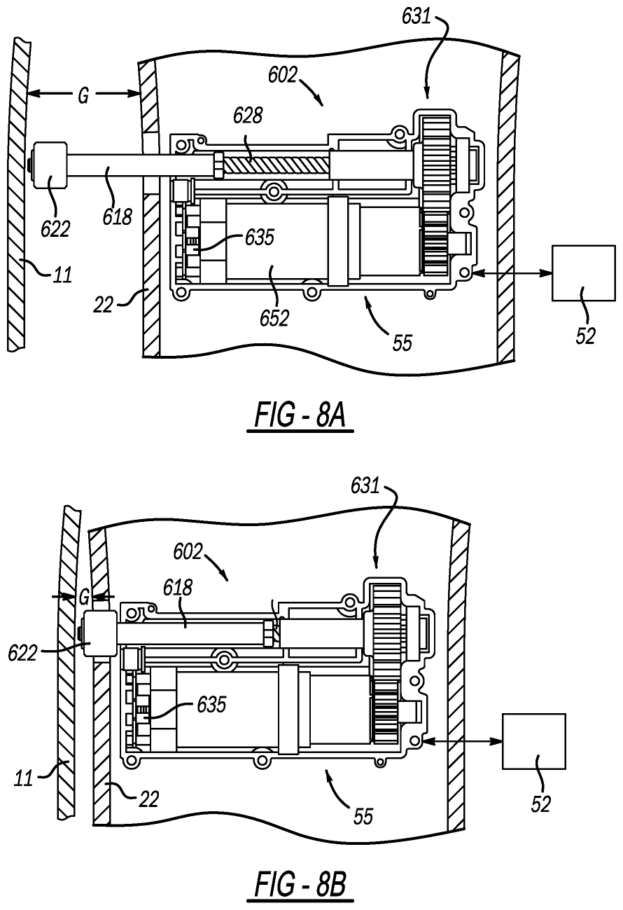

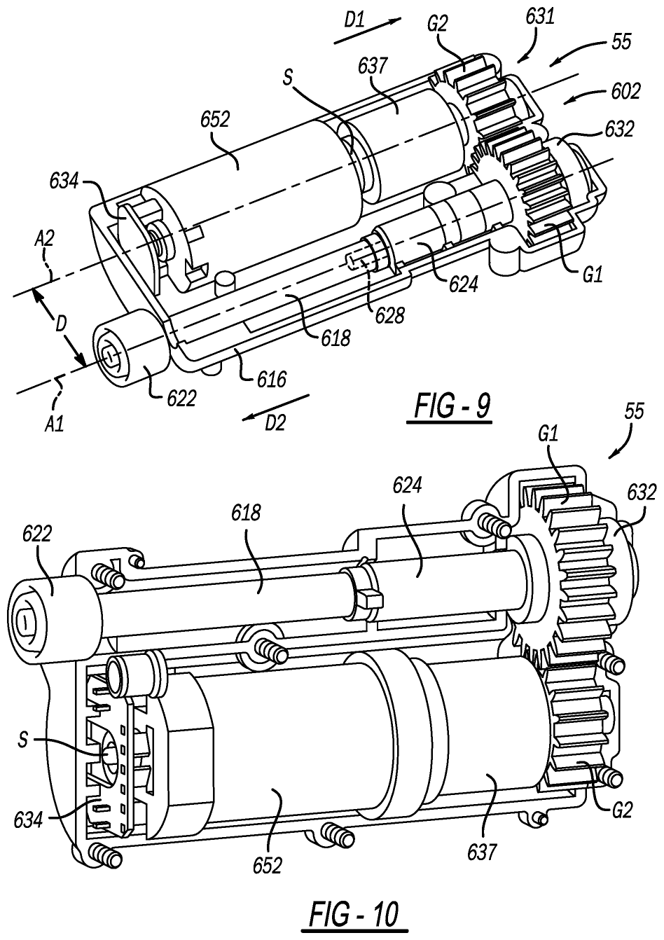

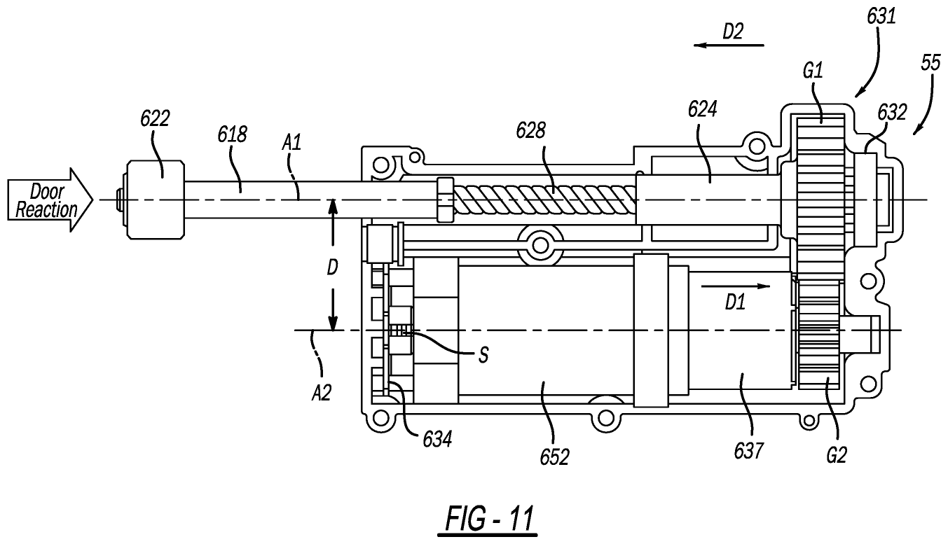

In FIGS. 6-10, a non-limiting embodiment of a power door presenter assembly 602 is shown in accordance with one aspect of the disclosure. The power door presenter assembly or a presenter mechanism, referred to hereafter as presenter 602, is illustratively shown as having a housing 616 defining a cylindrical chamber in which an extensible member 618 slides. The extensible member 618 can be configured having an external distal end having a bumper, such as an elastic bumper 622 for abutment with the vehicle body 11. The presenter 602 further includes an internally threaded cylindrical tube 624 which is rotatably connected to a lead screw 628 connected to a proximal end of the extensible member 618. The lead screw 628 is threadingly matable with the internally threaded cylindrical tube 624, also referred to as nut tube or nut 624, to permit relative rotation and translation between lead screw 628 and the nut tube 624. The extensible member 618 is non-rotatably and axially moveable on leadscrew 618 between a retracted position (FIGS. 8B and 10) and an extended position (FIGS. 8A and 11) relative to housing 616. When extensible member 618 is located in its extended position (FIGS. 8A and 11), front door 22 is urged into a partially opened deployed or “presented” position. The configuration of the lead screw 628 and nut 624 i.e. the thread pitch angles and geartrain unit are such so as to provide a manual reversibility of extensible member 618 from the deployed position to its retracted position, for example by urging the extension member 618 towards its retracted position by a closing of the door 22 abutting the elastic bumper 622. While presenter mechanism 602 is shown as having a linearly extendible member, also known as a plunger type presenter, other configurations of presenter mechanism 602 are possible which may include without limitation a pivoting lever type presenter mechanism, a configuration of a ratchet causing the ratchet to pivot and urge the striker attached to the door to move the door in to a presenter position. Presenter mechanism 602 maybe also be embodied as a power side door actuator configured for moving the door between any position between the closed position and the fully opened position, including a presenter position. Presenter mechanism 602 may be associated with a latch assembly (e.g. sharing a common mounting frame secured to the vehicle door as one example), or may be provided on a separate, distinct, and remote frame for mounting to a different part of the door. Possibly the presenter mechanism 602 may be mounted on the vehicle body alternatively to being mounted on the vehicle door.

In the embodiment shown in FIGS. 10 and 11, because the nut tube 624 is fixedly attached to a driven gear G1 for rotation in the housing 616 but is prevented from linear translation, as the driven gear G1 rotates in meshed engagement with a drive gear G2 in response to selective actuation of a motor 652, the nut tube 624 rotates, thereby causing the lead screw 628 and extensible member 618 fixed thereto to translate linearly along a first axis A1, causing the extensible member 618 to move with respect to the housing 616. Since the extensible member 618 is configured in this illustrated embodiment for abutment with the vehicle body 11 and the housing 616 is connected to the front door 22, movement of the extensible member 618 causes the front door 22 to pivot relative to the vehicle body 11. The lead screw 628 and the nut tube 624 thereby define a spindle-type rotary-to-linear conversion mechanism.

The lead screw 628 is rotatably connected to the nut tube 624 that is journaled in the housing 616 via any suitable bearing 632 that provides radial and linear support for the nut tube 624. A PCB 634 with sensor, such as a Hall-effect sensor 635, by way of example and without limitation, is mounted about a shaft S of the motor 652. The sensor 634 can detect motor shaft rotations and convert detected rotations into an absolute linear position electrical signal so that the linear position of the extensible member 618 is relatively known. In alternative embodiments, the sensor 634 can be provided as discussed above, such by a linear encoder which reads the travel between components that move relative to one another, so that the linear position of the extensible member 618 is known with certainty, even upon power up.

The motor shaft S is connected to a geartrain unit, also referred to as planetary gear box 637 for providing a gear reduction between the motor shaft S and the drive gear G2. The gear box 637 may be operably connected to a clutch unit that is normally engaged and can be energized to disengage to facilitate reversal of door presenter assembly. Further discussion here with regard to the clutch unit, given the discussion above, is believed unnecessary.

The motor 652 and the extensible member 618 are packaged within the housing 616 to provide a compact assembly having a minimal outer envelope, and in particular a minimized length (when compared to a configuration having the extensible member 618 and the motor 652 in a series arrangement having their longitudinal axes aligned), thereby requiring reduced space in which to mount the power swing door assembly 602. For example, in mounting positions in the vehicle door 22, the width of the door 22 can be correspondingly reduced due to the compact length of the power swing door assembly 602 (e.g. approximately half when compared to a series arrangement). In an illustrative embodiment, housing 616 may be integrally formed with the first and/or second front closure latch assembly 36, 40, such that integrated power door presenter assembly 602 is integrated with one or both latch assemblies 36, 40 (e.g. share the same housing for easy installation into the vehicle door 22 as a single unit). To provide the minimal outer envelope of the housing 616, the motor shaft S is oriented to extend along a second axis A2 that is parallel or substantially parallel (meaning that the axes A1, A2 may be slightly off parallel, such as by a few degrees) with one another. Further, the motor 652 and extensible member 618 are immediately adjacent, that is side by side, one another in laterally aligned and spaced relation by a distance D equal to the sum of the radii of the driven gear G1 and drive gear G2. Providing the axis of the motor 652 not co-axial or not concentric with the axis of extensible member 618 in a configuration whereby the longitudinal length of the actuator would be the sum of the longitudinal lengths of the motor 652 together with the extensible member 618 results in the reduction of the longitudinal length of the power-operated door presenter assembly 602, allowing the assembly 602 to be packaged in a widthwise direction within vehicle door 22 without requiring any vertical packaging space above or below the assembly 602 when installed in the door 22. Providing the extensible member 618 and motor 652 in a non-concentric and adjacent arrangement results in a further reduction of the longitudinal length of the power-operated door presenter assembly 602.

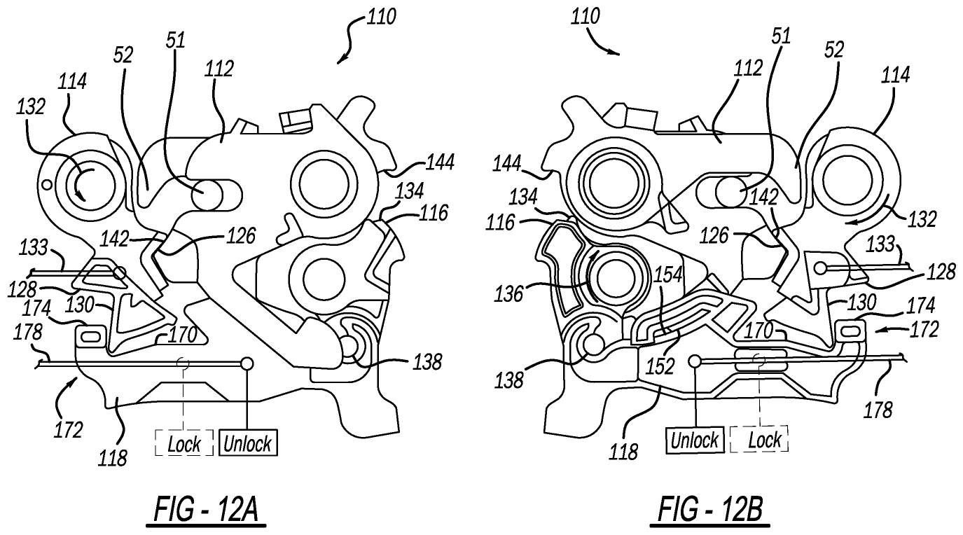

With reference to FIG. 11, the motor shaft S extends away from the motor 652, for example to the right in FIG. 12, along the second axis in a first direction, illustrated as arrow D1, and the extensible member 618 is moveable from the retracted position to the extended along the first axis in a second direction illustrated as arrow D1 pointing towards the left, different than the first direction D1. Illustratively, the motor 652 and the extensible member 618 are positioned adjacent one another in a side-by-side configuration on the same common side (e.g. on one side, that is the left side) of the gears G1, G2. Gears G1, G2 form a gear train or transmission train 631 configured to transmit torque from the motor shaft S to the extensible member. Optionally the gear train 631 may be configured to be back driveable to transmit torque from the extensible member to the motor shaft, for example via rotation of the nut tube 624 imparted by a linear movement of the extensible member, illustratively towards the right in FIG. 11.

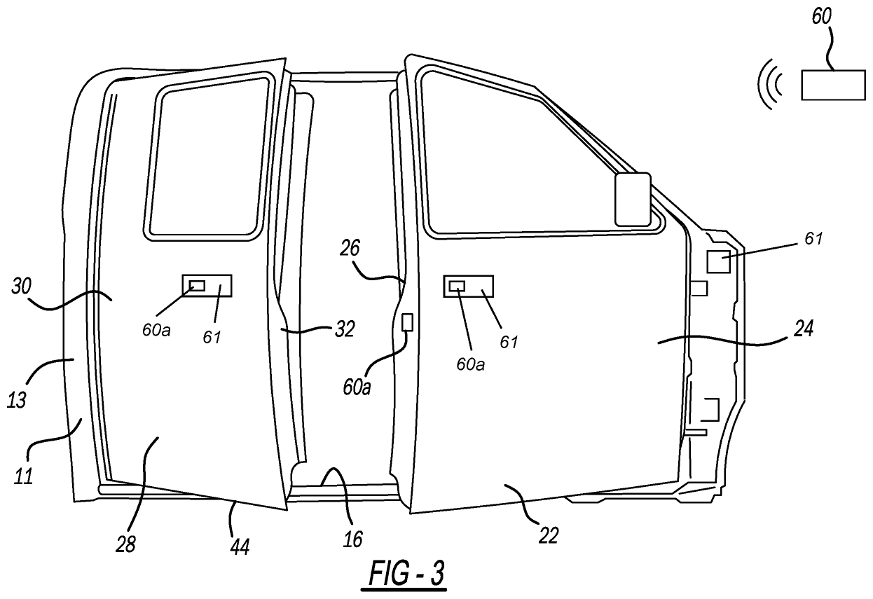

Upon receiving a present command, a controller, also referred to as electronic control unit (ECU) 53 (FIGS. 3, 6, 8A and 8B), can provide a signal to electric motor 652 of actuator 55 in the form of a pulse width modulated voltage (for speed control) to turn on motor 652 and initiate pivotal opening movement of vehicle door 22 towards its partially open deployed position (i.e. presented position) (recognizing that first and second front closure latch assemblies have also been signaled via ECU 53 to move to their unlatched states as further discussed below) via extension of extensible member 618. While the latch 36, 40 may have been signaled to be opened, it will be appreciated that initially the safety catch functionality will operate to catch and hold the door in a presented position.

While providing the signal, ECU 53 can also obtain feedback from sensors (not shown) to ensure that contact with an obstacle has not occurred or occurring as would be the case if an object or person is leaning upon the vehicle door 22 or otherwise that the user is present (e.g. is manually in charge of door 22). Similarly, if the latch did not open to the safety catch state to allow movement, sensors may determine that the presenter functionality is being blocked.

If no obstacle is present, motor 652 will continue to generate a rotational force to actuate spindle drive mechanism and thus extension of extensible member 618 until certain door positions are reached (e.g. 50 mm open position), the safety catch is engaged, or otherwise indicate that the user is present (e.g. hand is on the presented door 22 at the handle regions 69a and 69b for example). Once vehicle door 22 is positioned at the desired presented location, motor 652 is turned off. The user may then take control of door 22. Otherwise, upon signaling of manual control of door 22 by the user, the extensible member 618 may be retracted by ECU 53 actuating the motor 652 in the reverse direction. In the case of a power failure, the extensible member 618 may be easily retracted by a user closing the door to urge the extensible member to its retracted position.

It will be appreciated that other door presenter arrangements could also be used with the latch 40 having integrated safety catch functionality.

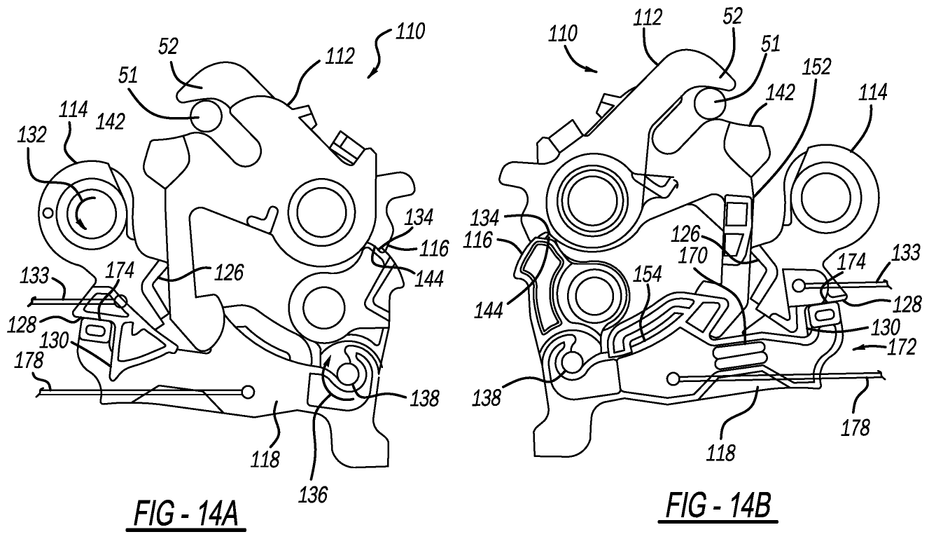

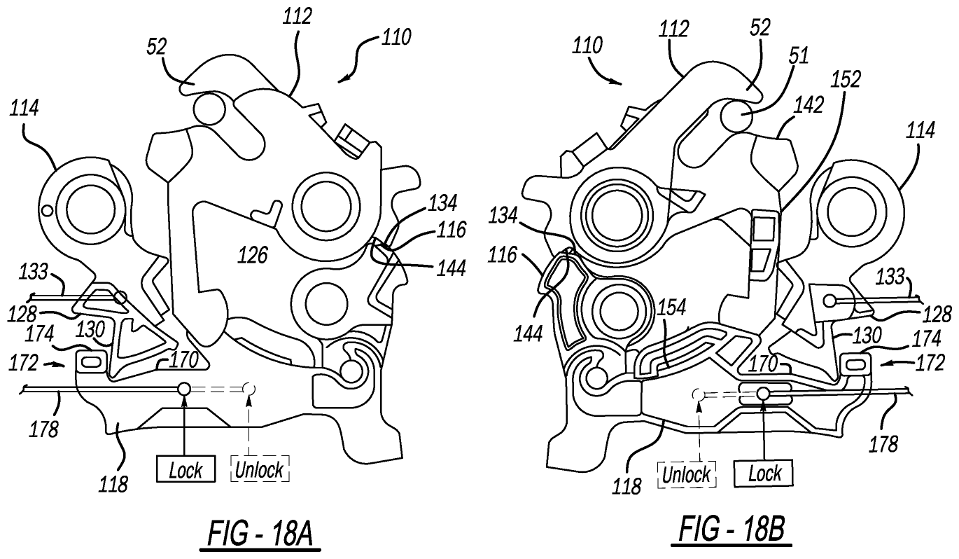

Referring to FIGS. 12A-19B, a latch assembly configured for use in one or both of first and second front closure latch assemblies 36, 40 is shown, wherein latch assembly is referred to hereafter as latch 110, and is illustrated and constructed in accordance with an aspect of the disclosure. Latch 110 includes a ratchet 112, a primary pawl 114, a secondary pawl 116, and a coupling link, also referred to as coupling lever 118. The ratchet 112 is movable between a primary striker capture position, also referred to as primary closed position (FIGS. 12A-13B, 16A-17B), a secondary striker capture position, also referred to as secondary closed position or safety catch position (FIGS. 14A-14B) and a striker release position, also referred to as an open position in response to selective movement of the primary and secondary pawls 114, 116. The pivotal movement of the ratchet 112 may take place about a pin 125 that can be mounted to a housing (not shown in these Figures). In the primary and secondary closed positions, the ratchet 112 prevents the withdrawal of the striker 51 that is mounted to the vehicle body 11. When in the primary closed position, the front door 22 is in a fully closed position, as compared to when ratchet 112 is in the secondary closed position, wherein the front door is in the presented position, but prevented from being moved to the fully open position by a safety catch portion 52 of ratchet 112.

As illustrated via these sequential figures, the safety catch portion 52 and the ratchet 112 move together about their pivot/rotational axis. The safety catch 52 and ratchet 112 may be a unitary structure or may be separate structures that are fixedly joined together for conjoint rotation, according to an aspect. Accordingly, safety catch 52 and ratchet 112 may be referred to separately, or safety catch 52 may be referred to as a portion of ratchet 112. it will be appreciated that both features operate the hold or capture the striker 51 in different positions of the latch 110 and the door 22.

Primary pawl 114 has a primary locking surface 126 configured for selective engagement with a primary lock surface 142 of ratchet 112 and is biased toward the primary locking position via any suitable biasing member, such as a spring member, shown schematically in FIG. 12B at arrow 132.

Secondary pawl 116 has a secondary locking surface 134 biased into abutment with ratchet 112 via any suitable biasing member, such as a spring member, shown schematically in FIG. 12B at arrow 136, by way of example and without limitation.

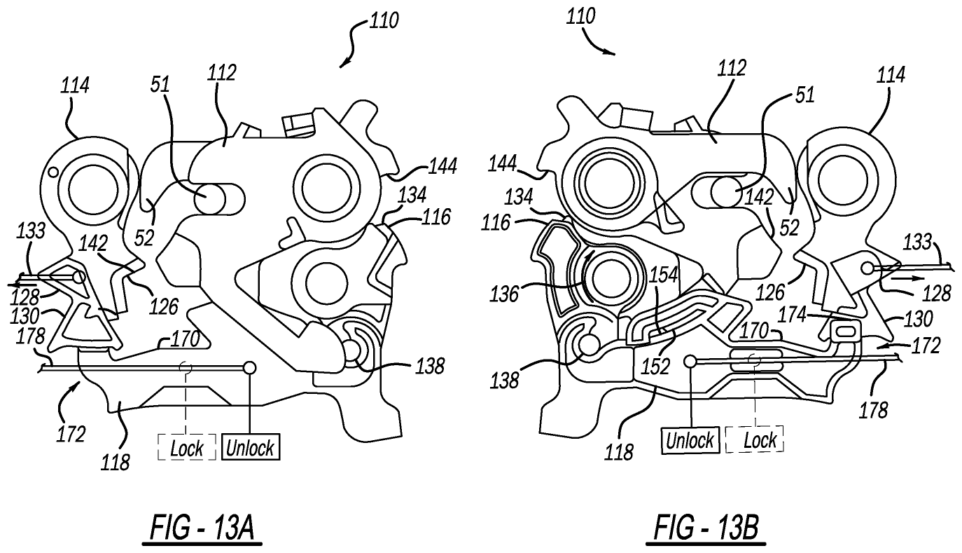

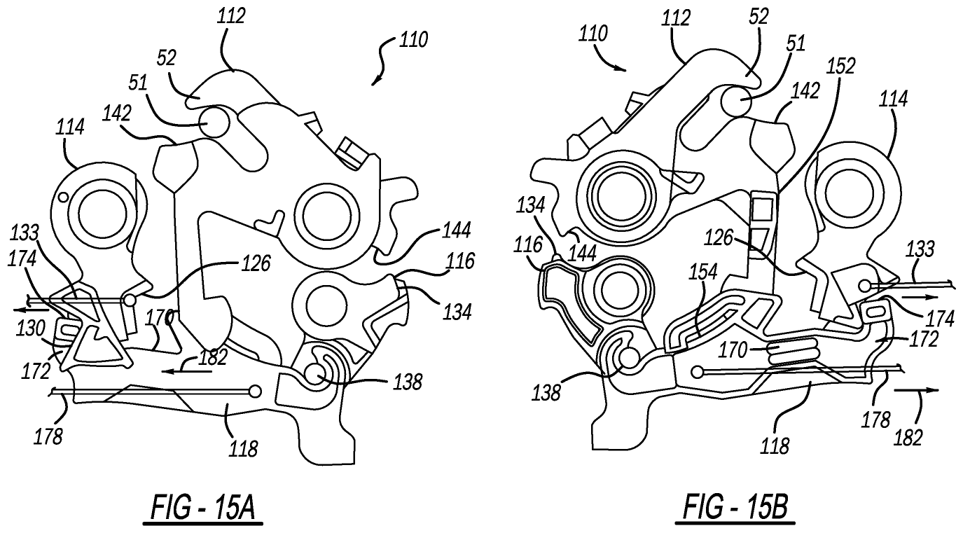

The coupling lever 118 is pivotably mounted to the secondary pawl 116 via pin 138 for movement between a disengaged position, also referred to as home position (FIGS. 12A-13B) and a connected position, also referred to as an engaged position (FIGS. 14A-15B). The coupling lever 118 is biased toward the engaged position by any suitable biasing member, and is shown as being biased schematically in the direction of arrow 136′ (FIG. 14A). Coupling lever 118 extends along a generally straight portion 170 from pin 138 to a generally hook-shaped portion 172 that terminates at a free end 174.

As shown schematically in FIG. 16A, latch actuator 176 is operably coupled to the coupling lever 118, such as via a rod or cable 178, by way of example and without limitation. The actuator 176 is configured in operable communication with ECU 53 and can be configured for communication with a sensor 180 to selectively maintain the coupling lever 118 in the home position, regardless of the position of the ratchet 112, in response to a predetermined state of the vehicle 10.

In use, in a normal release condition, with the coupling lever 118 in the home position and the ratchet 112 in the primary closed position (FIGS. 12A, 12B), movement of the primary pawl 114 from the primary locking position to the primary unlocking position (FIGS. 13A-13B) in response to a first actuation of the release member (e.g. pawl release member, such as rod or cable 133, by way of example and without limitation) causes the ratchet 112 to move from the primary closed position to the secondary closed position (shown in FIGS. 14A-14B). During movement of the ratchet 112 to the secondary closed position, a holding surface 152 of ratchet 112 slides along shoulder 154 of coupling lever 118 and ultimately moves out of contact with shoulder 154, whereupon the coupling lever 118 is automatically biased by biasing member 136′ to move from the home position to the engaged position. Upon the primary locking surface 126 of primary pawl 114 moving out from engagement from primary locking surface 142 of ratchet 112, a biasing member 140 (FIG. 14A) biases ratchet 112 to the secondary closed position, whereat secondary locking surface 134 of secondary pawl 116 engages secondary locking surface 144 of ratchet 112 to releasably maintain the ratchet 112 in the secondary closed position, with safety catch 52 blocking striker 51.

After performing a first actuation of primary pawl 114 (for example via cable 133) and rotation of ratchet 112, primary pawl 114 is biased by a biasing member 132 (FIGS. 12A, 14A) to return to its home primary locking position whereupon a second stop surface 128 of primary pawl 114 confronts and abuts free end 174 of coupling lever 118, thereby holding the coupling lever 118 in the engaged position (FIGS. 14A, 14B). Then, when desired to fully release latch 110, another repeated actuation of the primary pawl 114 is performed, causing movement of the primary pawl 114 to the primary unlocking position in response to a second actuation of the release member 133, whereupon a drive surface 130 of primary pawl 114 engages the hook-shaped portion 172 of the coupling lever 118 immediately adjacent free end 174 and moves the coupling lever 118 in translation generally along a direction indicated by arrow 182 (FIGS. 15A, 15B). With coupling lever 118 moved in the direction of arrow 182, the secondary pawl 116 is caused to pivot out from the secondary locking position to the secondary unlocking position (via 138), whereupon secondary locking surfaces 134, 144 move out of engagement from one another, whereupon ratchet 112 is caused to move under the bias of biasing member 140 from the secondary closed position to the open position. Safety catch 52 therefore moves along with ratchet 112 to release striker 51 and allow the door to be fully opened. At this time, front door 22 may be moved to the fully open position.

A predetermined condition can be implemented to prevent unwanted release of the ratchet 112 to the fully open position, thereby preventing the unwanted opening of front vehicle door 22. If the predetermined condition has been met, such as the motor vehicle 10 moving in excess of a predetermined speed, by way of example and without limitation, the ratchet 112 can be allowed to move from the primary closed position to the secondary closed position, but not to the fully open position. FIGS. 16A-19B illustrate a similar repeated actuation of cable 133, but with coupling lever 118 blocked from moving to the engaged position, such that a second actuation of cable 133 does not release the secondary pawl, so that the ratchet 112 and safety catch 52 will not further release striker.

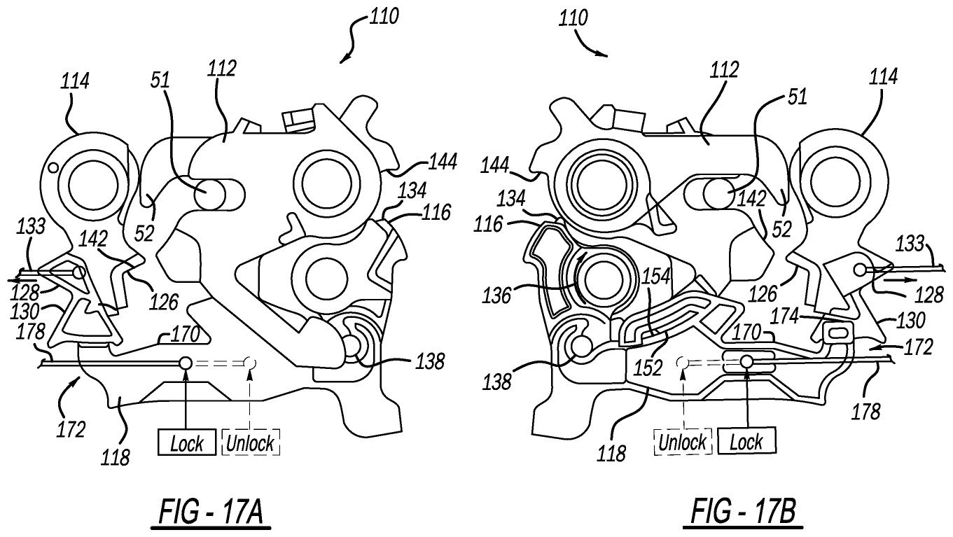

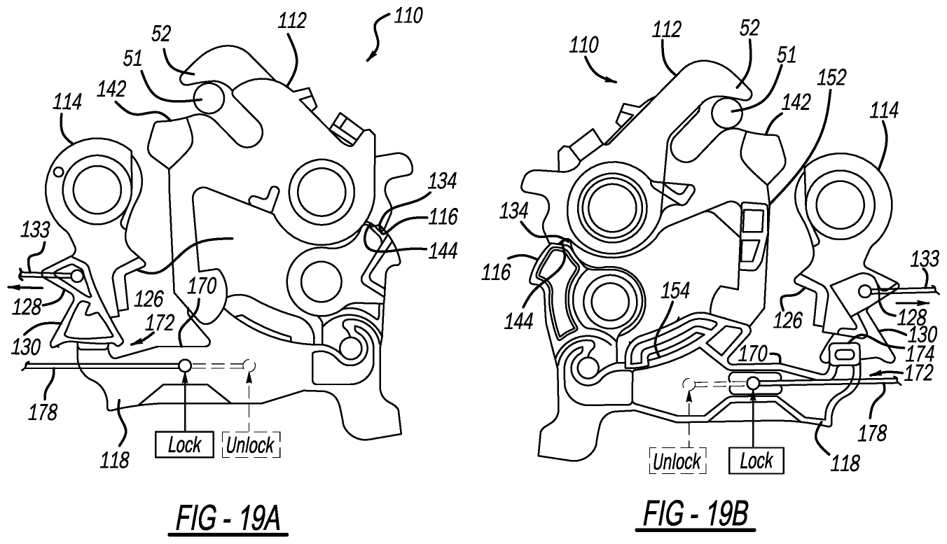

With reference to FIGS. 16A-19B, a normal mode of unlatching the latch 110 is shown, wherein the predetermined condition is met, such as engine running or vehicle traveling in excess of a predetermined speed (e.g. 5 km/h), by way of example and without limitation. Upon the predetermined condition being met, sensor 180 signals latch actuator 176 via ECU 53 to move cable or rod 178 within coupling lever 118 in the direction of arrow 186 (FIGS. 16A, 16B), whereupon coupling lever 118 is maintained in the disengaged, home position under the tension or force applied by cable/rod 178 on coupling lever 118 as long as the predetermined condition exists. Accordingly, the bias imparted by biasing member 136′ is overcome by cable/rod 178, thereby preventing the coupling lever 118 from moving toward the engaged position. With this, it is to be recognized that the coupling lever 118 can be released such that it can move from the disengaged, home position to the engaged position via actuator 176 returning the cable/rod 178 from the illustrated lock position to the illustrated unlock position upon the predetermined condition no longer existing. Upon being maintained in the disengaged, home position, the coupling lever 118 is maintained out from potential contact with primary pawl 114. As such, movement of the primary pawl 114 from the primary locking position to the primary unlocking position (FIGS. 17A-17B) in response to a first actuation of the release member 133 causes the ratchet 112 to move from the primary closed position to the secondary closed position, with safety catch 52 blocking striker 51 from further movement. However, it can be seen in FIGS. 19A, 19B that with the coupling lever 118 maintained in the disengaged, home position, a second actuation of primary pawl 114 fails to cause ratchet 112 to move from the secondary closed position, due to the hook-portion 172 of coupling lever 118 being maintained out of potential contact from drive surface 130 of primary pawl 114. Accordingly, the front door 22 is prevented from being able to open as long as the predetermined condition is met.

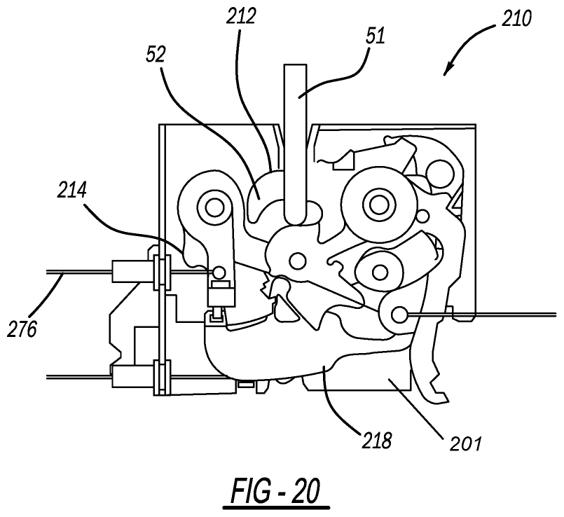

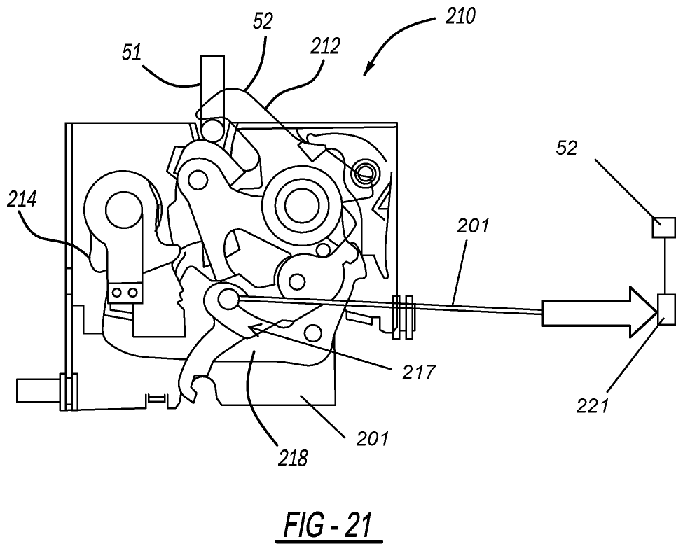

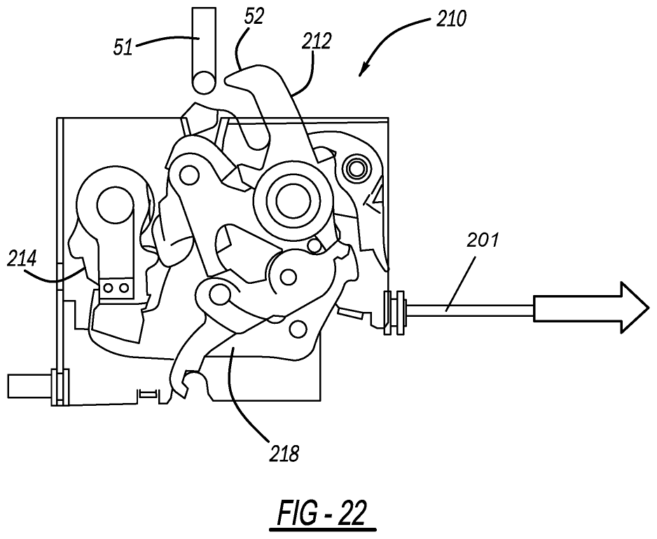

Referring to FIGS. 20-22, a latch assembly constructed in accordance with another aspect of the disclosure configured for use in one or both of first and second front closure latch assemblies 36, 40 is shown, wherein latch assembly is referred to hereafter as latch 210. Latch 210, unlike like 110, is a single pawl latch, and includes a ratchet 212, a pawl 214, and a coupling link, also referred to as coupling lever 218. The ratchet 212 is movable between a primary striker capture position, also referred to as primary closed position (FIG. 20), a secondary striker capture position, also referred to as secondary closed position or safety catch position (FIG. 21) and a striker release position, also referred to as an open position (FIG. 22) in response to selective movement of the pawl 214, such as via powered actuation of a latch actuator 276 (FIG. 20). The latch 210 is illustratively shown as configured as having a cinching mechanism 217 configured to move the passenger door from the presented position to the closed position. A bowden cable 219 is connected to the cinching mechanism of latch 210 which is illustratively shown as being actuated by a remote actuator 221 controlled by controller 52. A cinch mechanism 217 associated with any of the latch assemblies described herein may be controlled after the controller 52 determines expiry of a period of time following a first activation of switch 60a in order to return the door from the presented position to closed position. Upon the door being presented, or prior or simultaneous to the cinch mechanism being activated, the presenter mechanism may be moved from a presented position to a non-presented position to allow the cinch mechanism to move the door from the presented position to the closed position. Cinch mechanism 217, as well as latch assembly components 212, 214, 218 are shown mounted to a frame plate 201, the frame plate 201 which may then be mounted to the vehicle door for example.

In the primary and secondary closed positions, the ratchet 212 prevents the full withdrawal of the striker 51 that is mounted to the vehicle body 11. When in the primary closed position, the front door 22 is in a fully closed position, as compared to when ratchet 212 is in the secondary closed position, wherein the front door is in the presented position, but prevented from being moved to the fully open position by safety catch portion 52 of ratchet 212. As discussed above, pawl 214 is moveable from a primary locking position to a secondary locking position, whereat ratchet 212 moves from a primary striker capture position to a secondary capture position, and further, pawl 214 is moveable from the secondary locking position to an unlocking position, whereat ratchet 212 is allowed to move to its striker release position, via manual actuation and/or powered actuation of a release mechanism configured in operable communication with pawl 214, such as latch actuator 276.

As discussed above for latch 40, latch 210 is configured in operable communication with power-operated door presenter assembly 602 such that actuation of latch 210 to move ratchet 212 between the primary locking position, secondary locking position, and unlocking position can be coordinated in timed relation with desired actuation of power-operated door presenter assembly 602. As such, coordinated actuation of latch 210 and power-operated door presenter assembly 602 via receipt of a signal, such as from a key fob 60 or switch 60a (FIG. 3) via ECU 53, prevents inadvertent movement of door 22 from the presented position by maintaining the extensible member 618 of power-operated door presenter assembly 602 in the extended position while safety catch portion 52 of ratchet 212 retains striker 51 against release from latch 210. Switch 60a may be provided as part of a handle assembly associated with a power release function of the latch assembly, shown for example as external handle assembly 61, in electrical connection with controller 52. A first actuation of the switch 60a is sensed by the controller 52 to initiate a power release operation of the latch assembly, such one or more latch assemblies 36, 40, and operate the presenter mechanism 39 to move the door to the presented position once the latch assembly has been released. The safety catch 52′ is in a blocking position to prevent the door from moving to a position beyond the presented position. While safety catch 52′ has been shown to be integrated with a latch assembly 40 for engaging with striker 51, safety catch 52′ may be provided as separate and distinct from the latch assembly 40 and also be operable to engage or disengage with another part of the door, such as another striker, or a aperture formed in the door as examples. A subsequent second actuation of the switch 60a, such as within a predetermined period of time following the first actuation of the switch 60a, is sensed by the controller 52 to move the safety catch 52′ from a blocking position.

The above described coordinated movement of the power door presenter 602 and the latch 210 is likewise applicable to the latch 110 described above. The door presenter 602 may be maintained in its extended position to hold the door open and against a closing force below a threshold level, while the door 22 is blocked from opening further by the safety catch 52.

In one aspect, the latch 210 includes a cinching function, where the ratchet 212 may be cinched to secure the striker in the fully closed position. Cinching operations may be performed from the secondary latched position or presented position, either after the door is presented and as an alternative to opening the door 22, or after the door has been fully opened, and during a closing operation.

It is to be recognized that movement of ratchet 212 to its striker release position to allow release of striker 51 can be readily perfected via a selective second actuation causing pawl 214 to move to its unlocking position. Further yet, it is contemplated that upon door 22 being moved to the presented position, the user could signal door 22 to be returned to its closed position via a cinching operation of latch 210. Accordingly, upon moving door 22 to its presented position, the user has options to subsequently release door 22 for movement to its open position, or otherwise, to subsequently cause door 22 to move to its closed position.

Accordingly, latch actuator 276 is operable to move the pawl 214 from the primary locking position to the secondary locking position, and from the secondary locking position to the unlocking position, while presenter actuator 55 is operable to move the extensible member 618 from the retracted position to the extended position, with ECU 53 being operable to coordinate actuation of the latch actuator 276 and the presenter actuator 55 relative to one another. ECU 53 can be configured to signal actuation of the latch actuator 276 concurrently or in otherwise timed relation with actuation of the presenter actuator 55 to move the pawl 214 from the primary locking position to the secondary locking position at the same time or substantially the same time (slightly delayed actuation of presenter actuator 55) as the presenter actuator 55 moves the extensible member 618 from the retracted position to the extended position.

The latch actuator 276 is configured to maintain the pawl 214 in the secondary locking position and the ratchet 212 in the secondary striker capture position while the extensible member 618 is in the extended position to releasably maintain the passenger door 22 in the presented position absent the ECU 53 signaling the latch actuator 276 to move the pawl 214 to the unlocking position. Likewise, the presenter actuator 55 is configured to maintain the extensible member 618 in the extended position to prevent inadvertent movement of the passenger door 22 from the presented position to the closed position while the pawl 214 is in the secondary locking position absent the ECU 53 signaling the presenter actuator 55 to move the extensible member 618 to the retracted position.

As discussed above, switch 60a, shown located on an inner side of an edge of the passenger door 22 (FIG. 3), by way of example and without limitation, can be configured for manual actuation to signal powered actuation of the latch actuator 276 to move the pawl 214 from the secondary locking position to the unlocking position to allow the ratchet 212 to move from the secondary striker capture position to the striker release position, and to signal powered actuation of the presenter actuator 55 to move the extensible member 618 from the extended position to the retracted position when desired to move the passenger door 22 from the presented position to the open position. FIG. 3 shows a B-pillarless closure system 19 having door 22 mounted to an A-pillar of the vehicle, and door 28 mounted to a C-pillar of the vehicle, without a B-pillar disposed between the A-pillar and the C-pillar.

It is to be recognized that such coordinated actuation discussed above for latch 210 and power-operated door presenter assembly 602 is equally applicable for latches 36 and 40 and power-operated door presenter assembly 602. Similar signals and coordinated operation may be applied to the dual pawl arrangement of latch 110, where repeated actuation of cable 133 occurs to move from a safety catch position to a fully released position. The above description of the latch actuator 276 and its actuation of the latch 210 may be similarly applied to the latch actuator 176 and the latch 110.

It will be appreciated that following movement of the door 22 to the fully open position, the ECU 53 may signal to the door presenter 602 to retract the extensible member to the retracted position, such that the a door closing operation may not impart an undesirable force on the extensible member.

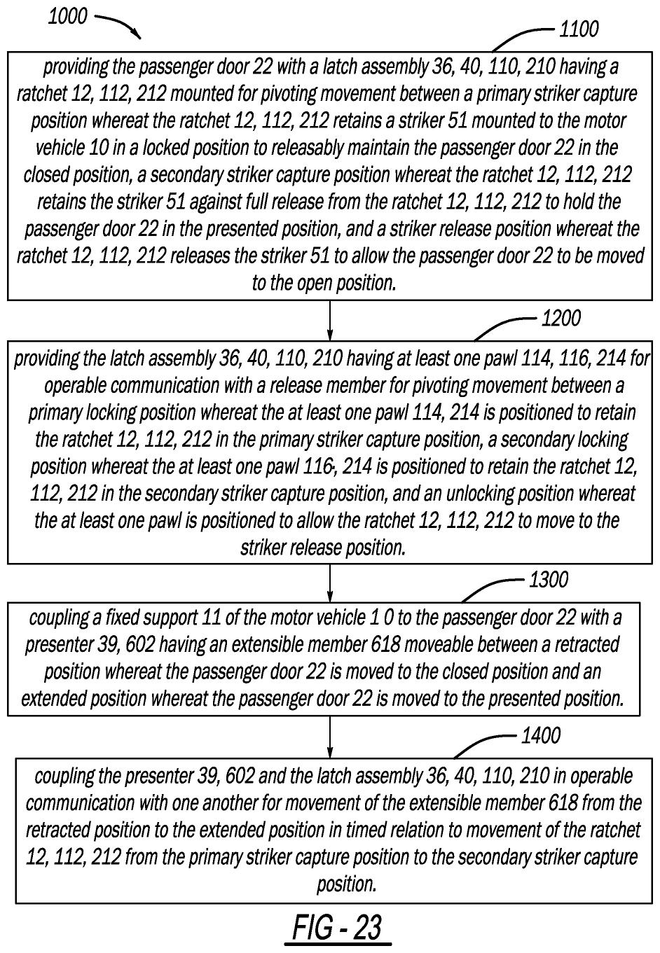

In accordance with another aspect of the disclosure, shown in FIG. 23, a method 1000 of constructing a passenger door 22 of a motor vehicle 10 for release from a closed position to a presented position and for maintaining the passenger door 22 in the presented position until desired to move the passenger door 22 to an open position or back to the closed position is provided. The method 1000 includes a step 1100 of providing the passenger door 22 with a latch assembly 36, 40, 110, 210 having a ratchet 12, 112, 212 mounted for pivoting movement between a primary striker capture position whereat the ratchet 12, 112, 212 retains a striker 51 mounted to the motor vehicle 10 in a locked position to releasably maintain the passenger door 22 in the closed position, a secondary striker capture position whereat the ratchet 12, 112, 212 retains the striker 51 against full release from the ratchet 12, 112, 212 to hold the passenger door 22 in the presented position, and a striker release position whereat the ratchet 12, 112, 212 releases the striker 51 to allow the passenger door 22 to be moved to the open position. Further, a step 1200 of providing the latch assembly 36, 40, 110, 210 having at least one pawl 114, 116, 214 for operable communication with a release member for pivoting movement between a primary locking position whereat the at least one pawl 114, 214 is positioned to retain the ratchet 12, 112, 212 in the primary striker capture position, a secondary locking position whereat the at least one pawl 116, 214 is positioned to retain the ratchet 12, 112, 212 in the secondary striker capture position, and an unlocking position whereat the at least one pawl is positioned to allow the ratchet 12, 112, 212 to move to the striker release position. Further, a step 1300 of coupling a fixed support 11 of the motor vehicle 10 to the passenger door 22 with a presenter 39, 602 having an extensible member 618 moveable between a retracted position whereat the passenger door 22 is moved to the closed position and an extended position whereat the passenger door 22 is moved to the presented position. Further yet, a step 1400 of coupling the presenter 39, 602 and the latch assembly 36, 40, 110, 210 in operable communication with one another for movement of the extensible member 618 from the retracted position to the extended position in timed relation to movement of the ratchet 12, 112, 212 from the primary striker capture position to the secondary striker capture position.

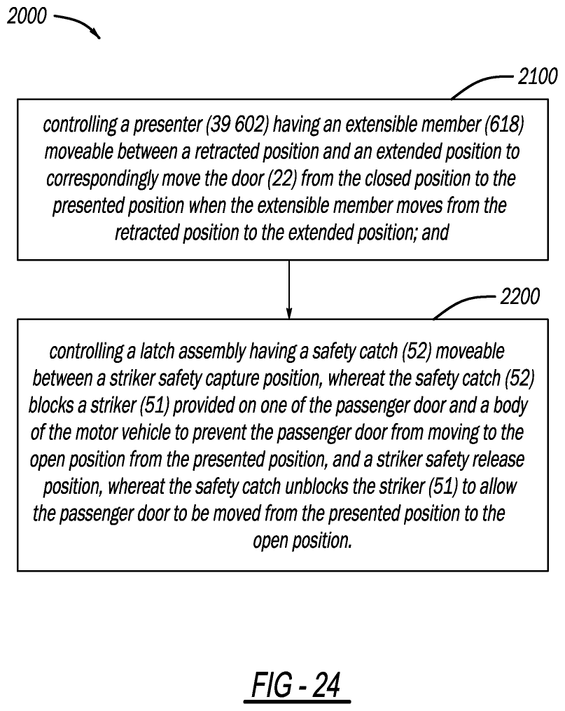

In accordance with another aspect of the disclosure, shown in FIG. 24, a method 2000 of controlling movement of a passenger door 22 of a motor vehicle from a closed position to a presented position is provided. The method includes, at step 2100 controlling a presenter 39, 602 having an extensible member 618 moveable between a retracted position and an extended position to correspondingly move the door 22 from the closed position to the presented position when the extensible member moves from the retracted position to the extended position; and, at step 2200, controlling a latch assembly having a safety catch 52 moveable between a striker safety capture position, whereat the safety catch 52 blocks a striker 51 provided on one of the passenger door and a body of the motor vehicle to prevent the passenger door from moving to the open position from the presented position, and a striker safety release position, whereat the safety catch unblocks the striker 51 to allow the passenger door to be moved from the presented position to the open position.

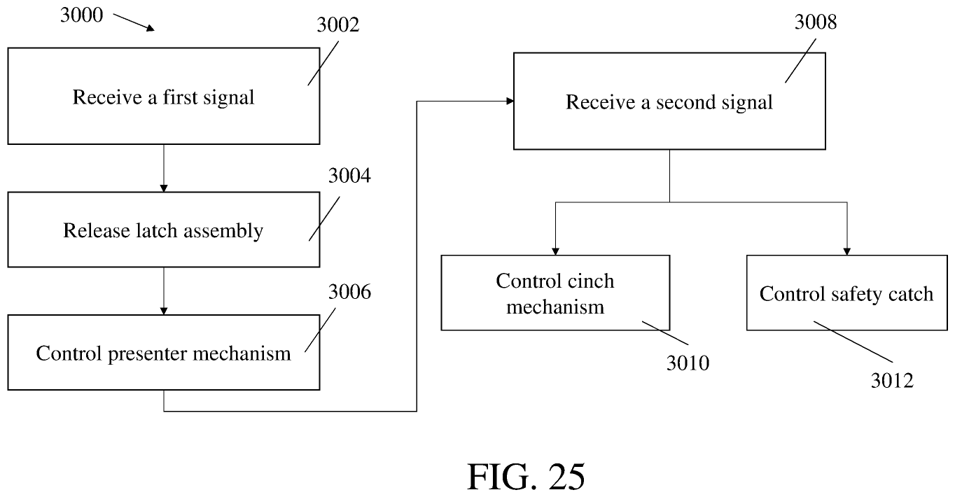

Now referring to FIG. 25, in addition to FIGS. 1 to 24, there is shown a method 3000 for controlling a present and hold door system. Steps of method may be carried out by a controller, or controller system, such as controller 52 for example. The method 300 includes the steps of receiving a first signal 3002, such as generated by a power release switch 60a. Next the method proceeds to step 3004 of releasing the latch assembly, such as by actuating a power release motor of the latch assembly. Next the method proceeds to step 3006 of controlling a presenter mechanism, such as by actuating a motor of the presenter assembly to move the door to a presented position. In the presented position, the door is prevented from moving away from the presented position to an open position by a safety catch in a blocking position and away from the presented position to a closed position by the presenter mechanism in the presented position. Next the method proceeds to step 3008 of monitoring for receipt of a second signal, such as a second signal from the power release switch 60a. If no second signal is detected, for example within a predetermined period of time e.g. ten seconds the method proceeds to step 3010 of controlling the cinch mechanism to move the door from the presented position to the closed position, such as by actuating cinch motor associated with the cinch mechanism. If a second signal is detected, for example within a predetermined period of time e.g. ten seconds the method proceeds to step 3012 of controlling the safety catch to move to a position to allow the door to be moved from the presented position to the open closed, such as by actuating a motor associated with moving the safety catch.

Accordingly, in view of the above disclosure, the disclosed latches that operate in controlled timed relation with the door presenter allows the door to be opened to an intermediate position via the presenter, with the latch allowing limited movement to the intermediate position. The door may be held in this partially open position against movement in both the opening and closing direction. In one direction, the door is prevented from opening further by the safety catch. In the other direction, the door is prevented from moving in the closing direction by the door presenter. Controlled operation beyond this position may be allowed by controlling the latch to move the safety catch out of position, allowing movement in the opening direction. Alternatively, controlled operation may be allowed by retracting the door presenter, allowing the door to move in the closing direction, with the striker engaging the latch. A cinching operation may be used to fully retain the striker and move the door into the fully latched and closed position.

Thus, the power door presenter and door opening operation may be used in windy conditions or inclined positions, as but two examples, where the door may be opened slightly and held in place against outside forces.

The foregoing description of the embodiments has been provided for purposes of illustration and description. It is not intended to be exhaustive or to limit the disclosure. Individual elements, assemblies and subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door system for a passenger door of a motor vehicle configured for movement between a closed position, a presented position, and an open position, comprising:
a presenter mechanism able to move the door from the closed position to the presented position; and
a latch assembly having a safety catch configured for movement between a striker safety capture position whereat the safety catch retains a striker in a blocked position when the door is in the presented position to prevent the passenger door from moving to the open position from the presented position, and a striker safety release position whereat the safety catch releases the striker from the blocked position to allow the passenger door to be moved from the presented position to the open position.

2. The door system of claim 1, wherein the presenter mechanism comprises an extensible member moveable from a retracted position whereat the passenger door is able to be moved to the closed position to an extended position whereat the passenger door is moved by the extensible member to the presented position, wherein, when the passenger door is in the presented position, the extensible member is in the extended position, and the safety catch is in the striker safety capture position, the passenger door is prevented from moving away from the presented position.

3. The door system of claim 1, wherein the latch assembly comprises a ratchet and pawl assembly configured to maintain the striker in a striker safety capture position to prevent the door from moving from the closed position to the presented position, wherein a first actuation of the latch assembly causes the ratchet and pawl assembly to release the striker to allow the door to move from the closed position to the presented position, and a second actuation of the latch assembly causes the safety latch to move from the striker safety capture position to the striker safety release position to release the striker to allow the door to move from the presented position to the open position.

4. The door system of claim 1, wherein movement of the safety catch to the striker safety capture position is coordinated with movement of the presenter mechanism to move the door to the presented position.

5. The door system of claim 4, further comprising a controller operable to coordinate the movement of the safety catch with the movement of the extensible member.

6. The door system of claim 1, further comprising a switch configured to signal movement of the safety catch from the striker safety catch position to the striker safety release position.

7. The door system of claim 6, wherein the switch is further configured to signal movement of the presenter mechanism to move the door from the closed position to the presented position.

8. A method of controlling movement of a passenger door of a motor vehicle from a closed position to a presented position, comprising:
controlling a presenter mechanism to correspondingly move the door from the closed position to the presented position; and
controlling a latch assembly having a safety catch moveable between a striker safety capture position, whereat the safety catch blocks a striker provided on one of the passenger door and a body of the motor vehicle to prevent the passenger door from moving to the open position from the presented position, and a striker safety release position, whereat the safety catch unblocks the striker to allow the passenger door to be moved from the presented position to the open position.

9. The method of claim 8, further comprising the step of controlling the presenter mechanism to maintain door in the presented position prior to controlling the latch assembly to move the safety catch from the striker safety capture position to the striker release position to allow the door to move from the presented position to the open position but not move from the presented position to the closed position.

10. The method of claim 9, further comprising the step of controlling the presenter mechanism to move prior to controlling the latch assembly to move the safety catch from the striker capture position to the striker release position to allow the door to move from the presented position to the closed position but not move from the presented position to the open position.

11. The method of claim 8 further comprising coordinating movement of the safety catch to the striker safety capture position from a striker capture position with movement of the presenter mechanism to move the door from the closed position to the presented position.

12. The method of claim 8 further comprising maintaining the door in the presented position and blocking movement toward the closed position by the presenter mechanism and blocking movement toward the open position by the safety catch .

13. The method of claim 8, further comprising the step of providing a ratchet and pawl assembly provided as part of a latch assembly configured to maintain the striker in a striker capture position to prevent the door from moving from the closed position to the presented position and configured to release the striker to allow the door to move from the closed position towards the one of the open position and the presented position;
controlling a first actuation of the latch assembly to cause the ratchet and pawl assembly to release the striker to allow the door to move from the closed position to the presented position, and controlling a second actuation of the latch assembly to cause the safety catch to move from the striker safety capture position to the striker safety release position to allow the door to move from the presented position to the open position.

14. A door system for a passenger door of a motor vehicle configured for pivotal movement between a closed position, a presented position and an open position, comprising:
a latch assembly for retaining a striker mounted to the motor vehicle and for releasing the striker to allow the passenger door to be moved to the open position;
a presenter mechanism configured to move the passenger door from the closed position to the presented position; and
a safety catch configured for movement between a blocking position to prevent the passenger door from moving to the open position from the presented position, and a release position whereat the safety catch allows the passenger door to be moved from the presented position to the open position.

15. The door system of claim 14, further comprising a controller configured to:
control the latch assembly to release the striker and control the presenter mechanism to move the passenger door to the presented position in response to receiving a first signal; and
control the safety catch to move to a release position to allow the door to be moved to an open position in response to receiving a second signal.

16. The door system of claim 15, wherein the first signal and the second signal are generated by activation of a power release switch.

17. The door system of claim 15, further comprising a cinch mechanism configured to move the passenger door from the presented position to the closed position, wherein the controller is configured to control the cinch mechanism to move the passenger door to the presented position to the closed position in response to the controller not receiving the second signal.

18. The door system of claim 17, wherein the controller is configured to control the cinch mechanism to move the passenger door to the presented position to the closed position in response to the controller not receiving the second signal after within a predetermined period of time.

19. The door system of claim 17, further comprising a frame plate for mounting to the vehicle door, wherein the latch assembly and the cinch mechanism are mounted to the frame plate.

20. The door system of claim 14, wherein the passenger door is part of a B-pillarless closure system.
